(19) United States
(12) Patent Application Publication
(10) Pub. No.: US 2021/0365972 A1
(43) Pub. Date: Nov. 25, 2021

(54) GAMIFICATION OF SDG ENTREPRENEURSHIP, CROSS-SECTOR COLLABORATION AND IMPACT INVESTING

(71) Applicant: Dream Tank, Boulder, CO (US)

(72) Inventor: Heidi Gitta Cuppari, Boulder, CO (US)

(21) Appl. No.: 16/794,047

(22) Filed: Feb. 18, 2020

Related U.S. Application Data
(60) Provisional application No. 62/808,216, filed on Feb. 20, 2019.

(51) Int. Cl. G06Q 30/02; G06Q 50/00; G06Q 40/06

(52) U.S. Cl. CPC G06Q 30/0209; G06Q 40/06; G06Q 50/01

(57) ABSTRACT

A method and system are disclosed for gamification of social impact entrepreneurship, cross-sector collaboration and impact investing. The game environment (100) includes a game platform (102) that can be accessed by gamers via the game terminals (103). The game terminals (103) access the gaming platform (102) via the portal (106). The users may access the design space module (108) to work on a solution to a selected problem. The platform 102 also includes an entrepreneurship space module (110). The module (110) assists gamers in learning entrepreneurship skills and developing a dream pitch to pitch the dream solution to impact investors. In the illustrated implementation, the platform (102) further includes an investment market module (114). The module (114) allows impact investors to invest in one or more selected dream solutions based on the dream pitches. The game environment can harness the creativity of children and teens to address defined SDGs, while directing the gamers towards commercially viable solutions and teaching entrepreneurship. The game environment can also be used to establish a market that attracts impact investors so as to sidestep structural impediments that can keep capital from flowing to sources of creativity.

### REFERENCE TO RELATED APPLICATIONS

This application is a non-provisional of U.S. Patent Application No. 62/808,216 entitled, “GAMIFICATION OF SDG ENTREPRENEURSHIP AND IMPACT INVESTING,” filed Feb. 20, 2019 (the “Parent Application”) and claims priority from the Parent Application to the maximum extent permissible under applicable laws and regulations. The Parent Application is incorporated by reference herein in its entirety.

### FIELD OF THE INVENTION

The present invention relates generally to harnessing the creativity of gamers, including children and teens, to address social and environmental problems through entrepreneurship. In particular, the present invention employs a gaming environment to develop business solutions to identified problems, such as attaining the United Nations' Sustainable Development Goals, and provides a platform for matching high quality solutions to cross-sector leaders and impact investors so as to enable realization of the solutions.

### BACKGROUND OF THE INVENTION

The capital markets that have evolved for investors are often at cross-purposes with the goals of sustainable development. Historically, the primary objective of capital markets has been to efficiently allocate resources to businesses with high growth potential so as to maximize the return on investment. This has generally governed both private and public markets. To the extent that high growth potential reflects the desires and needs of society, these markets may be viewed as promoting social good.

In recent years, potential investors have increasingly begun to question how well traditional markets function to properly allocate resources for the betterment of society. For example, individual companies with high growth potential may nonetheless have social or environmental impacts that individual investors find repugnant. More generally, the intrinsic market goal of growth is often in friction with the social and environmental imperative of sustainability. The objective of sustainability has been codified, for example, in the United Nations' Sustainable Development Goals (SDGs). Though the process is cumbersome, some investors attempt to take the SDGs into account in analyzing investment opportunities in traditional markets. These investors are sometimes called social impact investors.

It may also be questioned whether traditional markets are ideally suited to harness the creativity needed to achieve the SDGs. Despite the standard disclaimer, past performance is often viewed as predictive of future success. As a result, capital disproportionately flows to individuals and business models with proven track histories. This limits the potential of new voices and ideas.

However, it is becoming clear that the traditional mechanisms of business development are not addressing the SDGs at a sufficient pace and greater creativity is urgently needed. Neuroscientists have observed that children and teens are more creative than adults. Among other things, such research has confirmed that children and teens are more imaginative and less constrained by prior patterns of thought. In addition, the children and teens today have been born using technology such as the iPhone and more, and it is like a second—or even first—language for many. We call them the first digital natives on the planet. Such creativity is needed to achieve the SDGs. However, as noted above, capital markets are biased against new voices and ideas. Moreover, children and teens may be unfamiliar with or feel unwelcome to capital markets.

### SUMMARY OF THE INVENTION

The present invention is directed to a method and system for gamification of SDG entrepreneurship, cross-sector collaboration and impact investing. The game environment can harness the creativity of children and teens to address defined SDGs, while directing the gamers towards commercially viable solutions and teaching entrepreneurship. Conversely, the game environment can be used to establish a market that attracts impact investors so as to sidestep structural impediments that can keep capital from flowing to sources of creativity.

The process of the present invention involves building a design game space and a portal by which gamers can access the design game space. The design game space provides an environment where gamers can select problems related to a defined social or environmental impact objective, propose dream solutions to address the problems, use game resources to identify, investigate and solve challenges associated with the dream solutions, and accumulate game credits by addressing the challenges. The game space thus promotes creative thinking and problem solving. This may be accomplished in a real or digital environment. In the case of a real environment, the game resources may include subject matter experts and research materials. In a digital environment, such as an online gaming environment, the resources may include databases, search tools, digital assistants, messaging applications and subject matter experts, among other things. The portal promotes creativity by signaling to the gamers that they are entering a realm where anything is possible. In a physical game environment, the portal may include a tunnel or other passageway with appropriate decorations, sound stimuli, and the like to signal to the gamers that they are entering the creative environment. Similar stimuli can be generated for the digital game environment.

The game environment may further include an entrepreneurship game space. In the entrepreneurship game space, gamers can learn the basic tools of entrepreneurship including how to craft an effective pitch for a business model embodying a dream solution. In this regard, in the entrepreneurship game space, the gamers can access tutorials to attain entrepreneurship skills. In addition, the gamers can develop dream pitches related to the dream solutions by iteratively subjecting draft pitches to game resources, receiving feedback based on analysis of the draft pitches, and revising the draft pitches based on the feedback, thereby accumulating game credits. In the case of a physical game environment, the game resources may include coaches, mentors, or other experts who can help optimize the pitches for presentation to social impact investors. In a digital environment, the game resources may include applications for executing the noted functionality which may involve AI or other analysis tools, or human experts who interact with gamers through the game environment.

The game environment may further include a launch environment and a social impact investment marketplace. The launch environment can be accessed by authenticated gamers and social impact investors. In the launch environment, the gamers can present the dream pitches to the social impact investors. For example, the gamers may access the launch environment based on reaching a threshold of accumulated game credits. In this manner, gamers are inspired to fully develop dream solutions and dream pitches to appeal to social impact investors. At the same time, social impact investors are assured that the presentations are limited to the highest quality and most viable ideas. Game credits may be provided in any appropriate format such as points or grades and are preferably based on criteria related to technical and market viability. The social impact investment marketplace provides a market where the social impact investors can invest in one or more of the dream solutions based on the dream pitches. Such a market may be executed using conventional currency or crypto currency. Additionally, there is a need for corporations and leaders in other sectors to incorporate more innovation around the SDGs and sustainability/social impact into their charters/missions. These partners can propose design challenges and provide resources such as funding and mentors from their companies and communities.

### BRIEF DESCRIPTION OF THE DRAWINGS

FIG. 1 is a block diagram illustrating a game environment in accordance with the present invention;

FIG. 2 is a flowchart illustrating a process for using a game environment to develop a business solution for an impact investing marketplace in accordance with the present invention;

FIG. 3 is a flowchart illustrating a marketplace process in accordance with the present invention;

FIG. 4 is a flowchart summarizing a business development process from a game participant's perspective in accordance with the present invention;

FIG. 5 shows a user interface of the game environment of FIG. 1; and

FIG. 6 shows a further user interface of the game environment of FIG. 1.

### DETAILED DESCRIPTION

As discussed above, the invention may involve a physical game environment and/or a digital game environment such as an online game environment. Moreover, the invention may be implemented in a hybrid environment including an online game environment and a real-world environment. For example, the design space where gamers or participants can select problems, propose solutions, research challenges related to the proposed solutions and otherwise develop a dream solution may be executed online. Thereafter, pitches may be developed and presented to impact investors in a real-world environment. Accordingly, many game environments are possible in accordance with the present invention. In the following description, a fully digital or nearly fully digital game environment is described for purposes of illustration. It will be appreciated that the invention is not limited to this environment. Rather, certain aspects of the invention are applicable to real-world and hybrid environments.

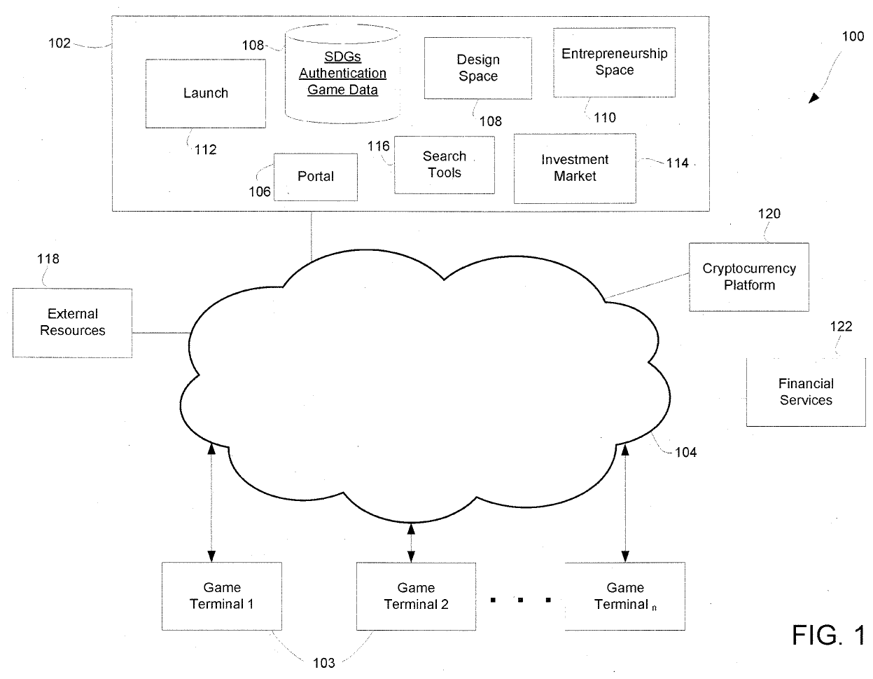

FIG. 1 illustrates a game environment 100 in accordance with the present invention. The illustrated environment 100 includes a game platform 102 that can be accessed by gamers via the game terminals 103. The platform 102 may be implemented on one or more machines at a single location or may be geographically distributed. The terminals 103 may access the platform 102 via a local area network, wide area network, or via the cloud 104.

The game terminals 103 may be embodied in any suitable user device such as a computer terminal, a dedicated gaming terminal, a mobile device, or other processor. The game terminals 103 access the gaming platform 102 via the portal 106. The portal 106 generates user interfaces, controls messaging between the gaming platform 102 and the terminals 103 as well as other external platforms as will be discussed below. In addition, the portal 106 provides graphics, sounds, and other effects to enhance the illusion that the gamer is entering a realm where anything is possible.

The platform 102 also includes one or more databases 108. The databases 108 may include information concerning SDGs, authentication information and other game data. Thus, for example, a gamer may access the database 108 via the portal 106 to browse and select problems related to one or more SDGs as the basis for developing a dream solution. The authentication data can be used to execute security functions and authenticate authorized gamers and impact investors who may access the platform 102. Various other kinds of game data may be included in the database 108 such as group memberships, entity affiliations, financial information, and the like.

The users may access the design space module 108 to work on a solution to a selected problem. The design space can assist users in developing dream solutions by identifying challenges related to the problem and assisting users in researching the challenges to develop solutions. For example, the design space module may include artificial intelligence and/or links to subject matter experts or other human resources in this regard. In one implementation, gamers may be guided in the game environment by a digital assistant, for example, rendered in the form of a cartoon or movie character. The digital assistant, who may be powered by an AI engine, can assist the gamer by identifying issues related to the selected problem for research, identify issues concerning technical or financial viability and otherwise prod the gamer to fully develop a viable solution. Additionally or alternatively, gamers may be linked to human subject matter experts via the platform 102. The links may enable instant messaging, email, videoconferencing or other communication between one or more gamers and one or more subject matter experts. Examples of such subject matter experts include scientists, engineers, government officials, investors, investment advisors, venture capitalists and the like.

In addition, gamers can partner with sector leaders, or other business leaders or experts in the field, who can help develop ideas, implement business plans, and assist the gamers in scaling their solutions. For example, businesses may provide mentors or subject matter experts in the field of a business plan proposed by a gamer or group of gamers/participants. Gamers thus have an opportunity to collaborate with mentors so as to improve scalability, practicality and readiness for investment or acquisition.

The illustrated platform 102 also includes an entrepreneurship space module 110. The module 110 assists gamers in learning entrepreneurship skills and developing a dream pitch to pitch the dream solution to impact investors. In this regard, the module 110 may include online tutorials and other resources to teach entrepreneurship skills. In addition, the module 110 may include analysis tools whereby users can present draft pitches and receive feedback concerning the pitches. These tools may include artificial intelligence and/or coaches, mentors, experts, or other human resources.

As discussed above, gamers may accumulate game credits based on achieving certain defined benchmarks. For example, in connection with the design space module 108, gamers may accumulate points based on developing solutions that are fully developed, technically viable, and commercially viable. Similarly, in connection with the entrepreneurship space 110, gamers may accumulate points based on the completeness and effectiveness of a pitch. When a gamer has accumulated game credits reaching a predefined threshold, the gamer may access a launch platform 112. The platform 112 may also be accessed by participating impact investors. At the launch platform 112, the gamers can present the dream pitches to the social impact investors. This may be done in a one to one, one to many, or many to many environment, online and/or offline. In addition, the presentations may be static or interactive. Thus, for example, an impact investor may simply select and view a pre-recorded pitch. Alternatively or additionally, a gamer may interact with an impact investor or investors via a messaging application or videoconferencing, or through one of the in-person Dream Tank Collective Impact summits.

In the illustrated implementation, the platform 102 further includes an investment market module 114. The module 114 allows impact investors to invest in one or more selected dream solutions based on the dream pitches. In this regard, the module 114 may include a contracting application to execute contracts related to investments and transaction applications for settling investment transactions.

The illustrated platform 102 also includes search tools 116 that can be used by gamers, investors, and others. For example, gamers may use the search tools to access the database 108, to access research databases separate from the platform 102, or to access other resources relevant to the problem being addressed. Potential investors may utilize the search tools to identify investment opportunities or to conduct research regarding the problem, the gamer, the gamer group, or other information relevant to an investment opportunity. The search tools 116 may also be accessed by other members of the public, to the extent that this is permitted by the platform 102, to learn about the gaming environment, SDGs, or other information.

The gaming environment may also include external resources 118 such as research tools, financial information, or other information useful for the game environment 100. Execution of investments may involve a crypto currency platform 120 or other financial services platforms 122. In preferred implementations, investments may be fulfilled using crypto currency. However, it is also possible to execute investments using conventional financial services platforms.

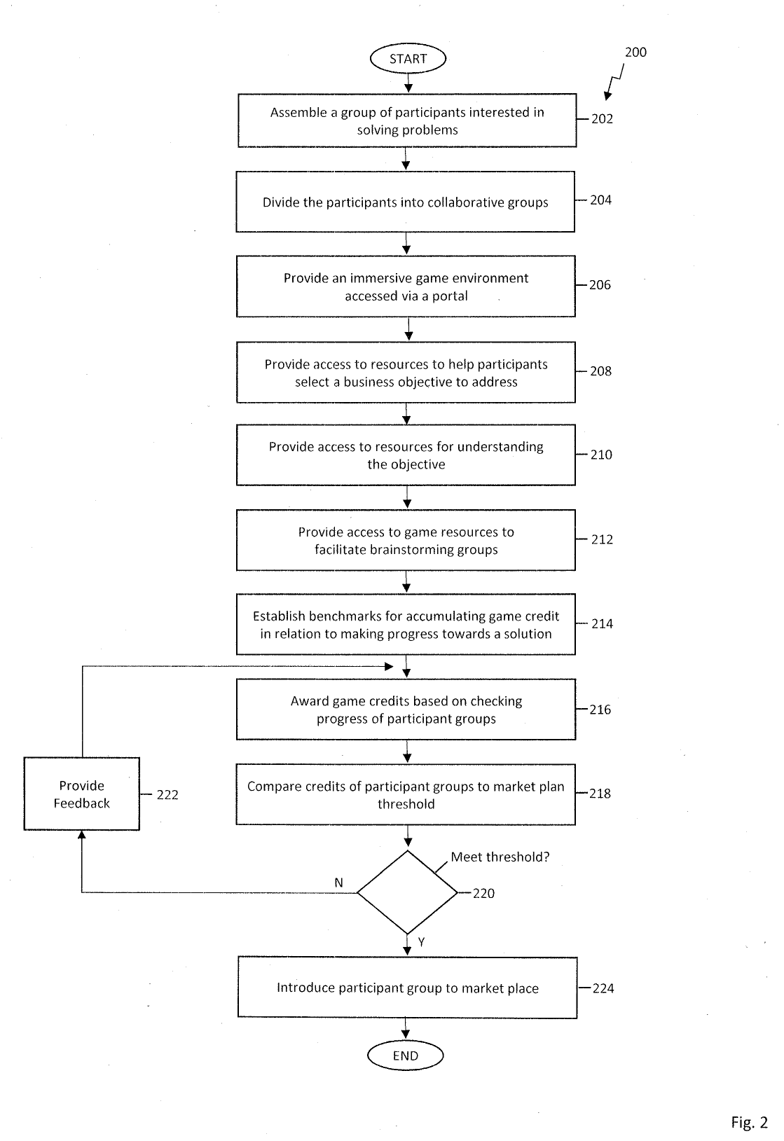

FIG. 2 illustrates a process 400 for developing and using a game environment to develop a business solution for an impact investing marketplace in accordance with the present invention. The illustrated process 200 is initiated by assembling (202) a group of participants interested in solving problems. It is believed that a particularly advantageous application of the present invention relates to realizing the potential of children and young adults to bring fresh perspectives to seemingly intractable problems, particularly problems that will impact the future lives of children and young adults. In this regard, the invention may be implemented in connection with workshops or seminars provided by schools, youth groups, summer programs or the like.

The participants may then be divided (204) into collaborative groups. It is believed that such groups facilitate brainstorming and development of workable solutions. The size of such groups may vary depending on the age of the participants, the characteristics of the participants, the availability of adult mentors or advisors, and other factors. In addition, it may be found that different sizes of groups are more productive for different environments, such as online versus real world implementations of the game. In real-world environments, groups of no more than five children or young adults with an adult mentor have been found to be productive. Smaller or larger groups may be accommodated in either real-world or online environments. In either case, a virtual assistant, either in place of or in addition to human mentors, may be utilized to guide the participant group in its brainstorming and development process. The virtual assistant may implement artificial intelligence (AI) to guide the participant group towards goals in response to inquiries and other inputs. The participants may be divided into groups by random or pseudorandom assignment, based on mutual interests, or based on self-selection by the participants, among other possibilities.

The participant groups may then access an immersive game environment (206) via a portal. An objective of the game environment is to encourage the participants to be creative. In one implementation, this is facilitated by providing a game environment where participants are, at least in the first instance, metaphorically freed from real-world constraints that may inhibit brainstorming. It is believed that a variety of virtual game environments can serve this purpose. For example, it is been found that many children and young adults respond favorably to the virtual construct of a hero's journey through an imaginary or unfamiliar environment such as space, an exotic location, or a different historical or future time period. In real-world game environments, the game space may be housed in a dome or other space that is dedicated to or specifically adapted for the game. This space may be entered via a portal where sight, sound and other stimuli are provided to enhance the illusion of entering an alternate world of possibilities. In virtual environments, the immersive experience may be enhanced by appropriate graphics, sound effects, virtual reality effects and the like, all of which may be accessed via a virtual portal.

Once the participants have entered the portal, they can access various resources (208) to select a business objective to address. It should be appreciated that any business objective can be addressed using the game and process of the present invention. However, the present invention has particular advantages for bringing together impact investors and other cross-sector with suitable business ideas and models. Accordingly, the resources may be specifically adapted to steer the participants towards objectives that match the values and interests of a target impact investment community. In addition, the invention is particularly well-suited to empower children and young adults. As discussed above, children and young adults are believed to represent an underutilized resource for addressing some of society's most pressing problems. These young people also often have a natural empathy and long-term interests that can inspire participants to pursue thoughtful and creative solutions.

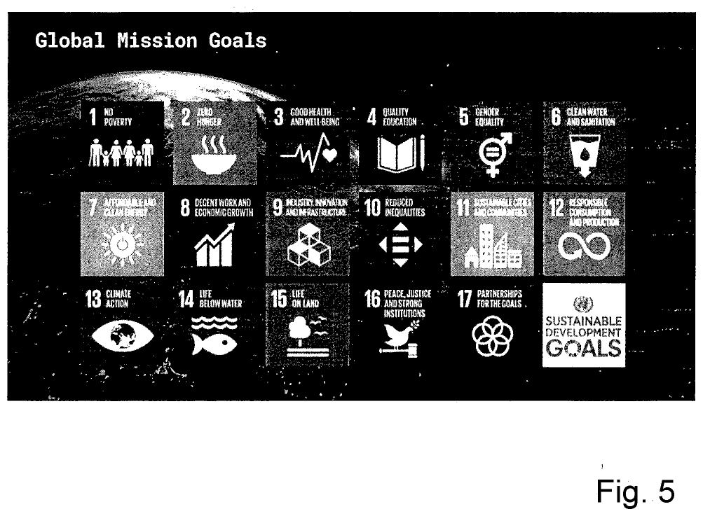

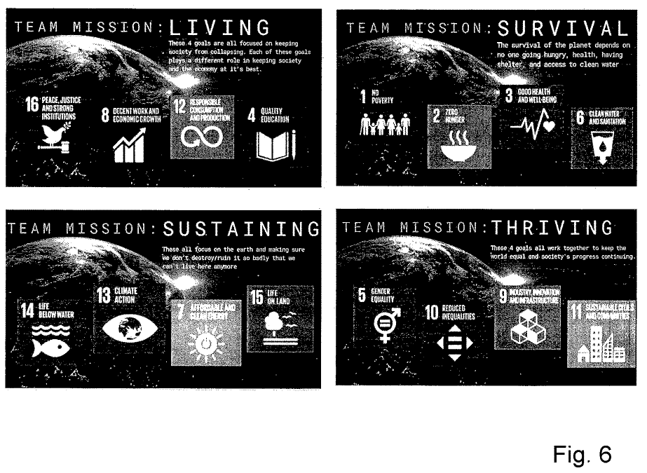

Thus, in one implementation, resources are provided to steer participants towards addressing some of society's most pressing issues, such as those encompassed by the UN's 17 Sustainable Development Goals (SDGs). In real game environments, literature and computer resources, as well as human subject matter experts, may be provided in a designated area of the physical game space. In virtual game environments, participants may be directed to a graphical “objectives” interface such as shown in FIG. 5. To further assist participants in narrowing the areas of interests, such objectives may be categorized as shown in FIG. 6.

Inspiration often requires a deeper understanding of the nature of the problems or goals. Accordingly, the game facilitates access to resources (210) for understanding the objective. For example, if a participant selects SDG 2 (zero hunger) of the user interface of FIG. 5, the participant may be presented with options to learn about the prevalence of hunger, the reasons for inadequate food supplies, and unused resources, among other things. An AI powered digital assistant may assist the participant in exploring topics of interest, for example, by asking and answering questions and introducing video clips and other resources. In a real game environment, literature, data terminals and human subject matter experts may be available in a designated research area, for example, organized according to the UN SDGs. In either a real or virtual game environment, participants may have the opportunity to work with remote subject matter experts via instant messaging, text, video conferencing or the like. In this regard, the platform 102 (FIG. 1) may include communication portals, a database of willing and qualified subject matter experts, and search functionality for facilitating such connections.

Once the participants have selected an objective or area of interest and have educated themselves about the objective, the participants can engage in brainstorming to identify potential solutions and viable business models to implement the solutions. Particularly for young people, such brainstorming may be facilitated by gamification. In the case of a virtual game space, the format of the game may break down progress towards a solution into tasks or checkpoints and award points or game credits to reward progress. For example, the game may be styled as a “hero's journey” with a goal matched to the objective selected by the participants. Thus, if the participants selected to address the problem of hunger in a geographical region susceptible to drought, a game may be generated where the participants attempt to save a fictitious village suffering from food shortage. The journey to save the village may include a number of checkpoints corresponding to solving intermediate problems towards achieving a solution. Through this process, for example, the participants may learn that many villages could have access to irrigation water if they could afford certain equipment, leading the participants to brainstorm about inexpensive alternatives for pumping water. The participants may use additional resources to develop potential pump designs and estimate production costs. In real-world game environments, participants may access similar online resources as well as hardcopy resources and materials for assembling models or prototypes.

The game may be designed to encourage a variety of attributes in relation to potential business ideas of interest to impact investors. These may include, among others, addressing an objective of substantial interest to potential impact investors, developing a solution that is technically feasible, and developing a solution that is feasible from a business perspective. To encourage progress towards developing a workable solution, the game operators may establish (214) benchmarks for accumulating game credits based on progress of the participant groups. Thus, for example, points or game credits may be awarded based on selecting an objective of substantial interest, completing background research, proposing a solution that addresses an important problem, proposing a solution achieving a high technical feasibility score, completing a suitable market and cost analysis, achieving a high business feasibility score, and preparing an effective presentation of the idea. The various opportunities to accumulate game credits may be weighted based on difficulty, level of development, level of success and to promote attention to attributes that have not been adequately addressed.

As noted above, an important goal of the game is not only to develop potential solutions but also to launch the solutions in the real world through investment by impact investors. This goal can be promoted by ensuring that only high-quality, well-developed business proposals are pitched to the impact investment community. The game credits can be designed to promote this objective and ensure that this goal is met. As noted above, the benchmarks for accumulating game credits can be designed to encourage the desired attributes of the business plan. Then, progress of the participants can be checked (216) to monitor progress towards a business plan that is ready to be pitched to the impact investment community. The credits accumulated by the participant groups can then be compared (218) to a defined threshold indicating that the idea is ready to be pitched. If the threshold is met, the participant groups may be introduced (224) to the impact investment marketplace to make their pitch. Otherwise, the business idea may be analyzed to determine where improvement is possible and appropriate feedback may be provided (222) to the participant group. The participant group can then revise the business idea with an eye towards accumulating sufficient credit to reach the threshold.

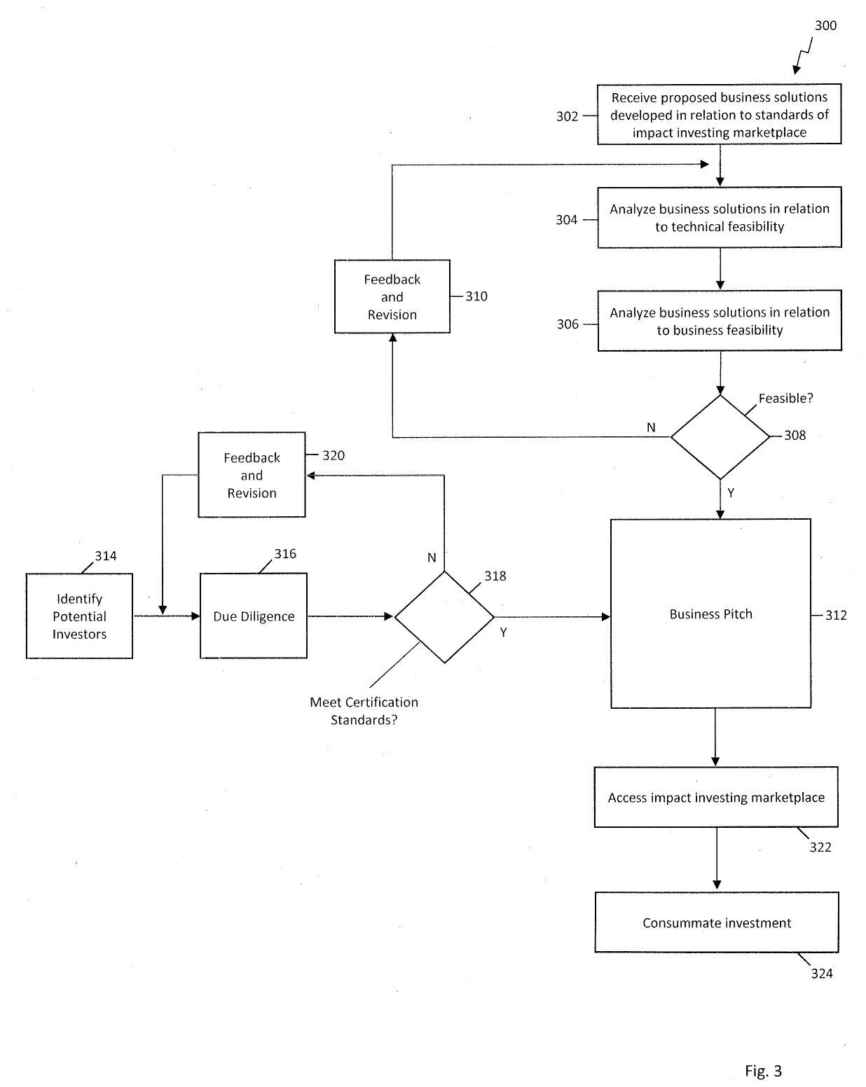

This is further illustrated by the marketplace process 300 of FIG. 3. In the discussion above, it was noted that, particularly in the case of young people, participants may initially pass through an allegorical portal to a game space where real world impediments to creativity are reduced. The participants may pass again through the portal to bring the business idea back to the real world. This may involve consideration of various aspects of real-world feasibility. In the illustrated process 300, the game or game operators first receive (302) proposed business solutions developed in relation to specified standards of the impact investment community, such as advancement of the UN SDGs. The solutions are then analyzed (304) in relation to technical feasibility. This may involve automated AI analysis and/or analysis by subject matter experts. For example, such analysis may determine that a proposed water pump design has insufficient capacity or is not sufficiently robust for the environments where it is likely to be deployed.

Similarly, the proposed solution may be analyzed (306) in relation to business feasibility. Again, this may involve automated AI analysis and/or subject matter experts. For example, this analysis may determine that the real costs are higher than estimated or that the market is smaller than expected. Based on these analyses, if it is determined (308) that the business idea is ready, the participants may be invited to make a pitch to the target impact investment community. Otherwise, feedback (310) may be provided to the participants and they may take the feedback into consideration in revising the business plan. For example, the participants may need to brainstorm about how to increase pump capacity or adapt the design to be applicable to more communities in need. Potential investors are thus assured that ideas are properly vetted before being pitch and only the highest quality plans are being presented.

It is also important that the potential investors are screened to ensure that their goals match those of the participants, that they are willing to abide by the rules of the marketplace, that participants are not improperly exploited, and that the investors have the experience and credentials to improve prospects for a successful launch. In this regard, the illustrated process 300 involves identifying (314) potential investors. For example, applications to participate in the market may be solicited from established impact investors. A due diligence process (316) may then be performed to ensure that the potential investors have appropriate goals, objectives, and credentials as described above. If so, the potential investors are certified (318) to receive pitches and access the marketplace. Otherwise, the potential investors may be rejected or counseled (320) as to potential revisions of goals or practices to get certified. Such certification is believed to be particularly important to protect young game participants and to ensure fidelity to the objectives of the impact investor marketplace.

After the pitch, certified impact investors can access (322) the impact investment and collaboration marketplace. Such access may be online, e.g., via an investment portal, or by face to face negotiations. An investment may then be consummated (324) by forming an entity to pursue the proposed business plan and receiving an investment from a certified impact investor.

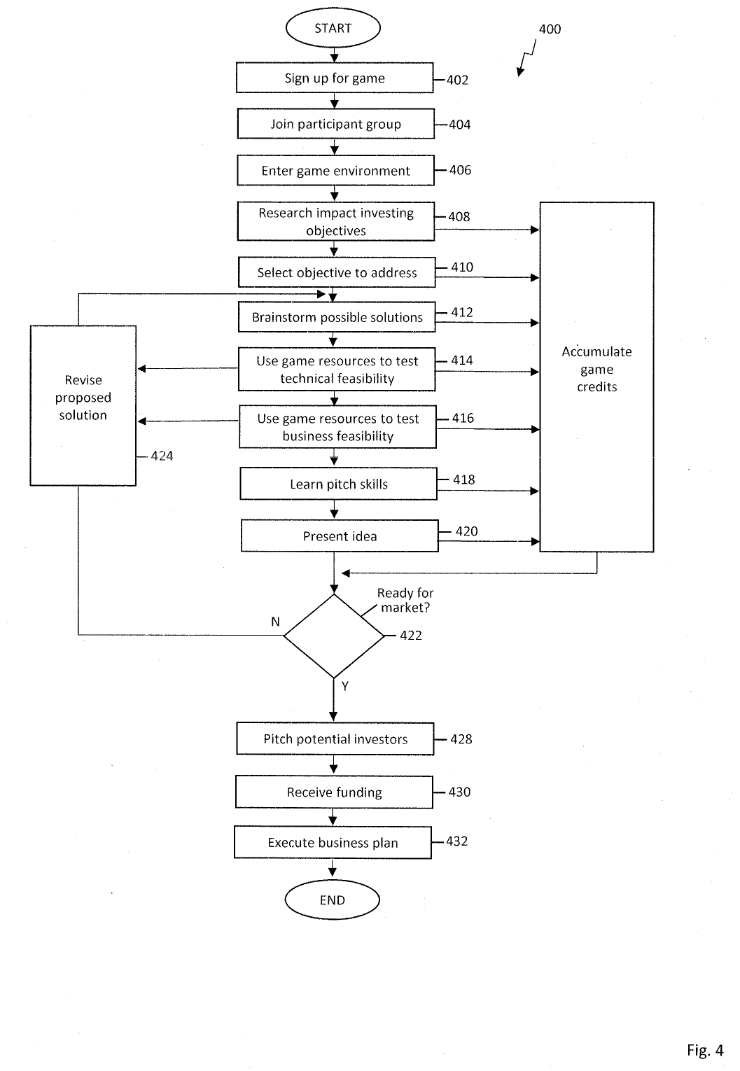

FIG. 4 is a flowchart summarizing a business development process 400 from a game participant's perspective. The illustrated process is initiated by signing up (402) for the game. In real-world implementations, this may involve signing up for a workshop, seminar, summer program or the like. In online contexts, this may involve accessing a game portal and registering for the game. Although it is possible for a participant to play the game alone, in many cases, it is anticipated that the participant will join (404) a participant group to enhance the experience and allow for collaboration.

The participants can then enter (406) the game environment. As discussed above, this may involve passing through a portal into an immersive game space. In real-world contexts, this may involve entering a dome or other physical game space. In virtual game environments, this may involve passing through a virtual portal into a virtual world designed for the game. Upon entering the game space, the participants may be prompted to research (408) impact investing objectives and other SDG objectives of potential cross-sector collaborators. For example, the participants may be steered towards business objectives that match the investment objectives of a target impact investing community. Thus, for example, the participants may be presented with a user interface that identifies a set of appropriate objectives and includes links to research resources associated with those objectives. Through this process, the participants may select (410) a business objective to address through a business plan.

Once the objective has been selected, the participants may brainstorm (412) possible solutions and begin work on an associated business plan. In some cases, the participants may develop multiple potential solutions to test through the game process. The participants can then use (414) game resources to test the technical feasibility of one or more of the possible solutions.

For example, an AI assistant may lead the participants through a series of queries designed to test technical feasibility. Additionally or alternatively, the participants may work with a subject matter expert to identify potential issues concerning feasibility. Similarly, the participants may use (416) game resources to test the feasibility of the business plan from a business perspective. This may involve estimating costs, determining the availability of resources to fund a product or service, and determining the size of the market, among other things. An AI assistant or subject matter expert may be employed to facilitate this analysis.

In addition to testing the technical and business feasibility of a business plan, the game process may involve assisting the participants in developing the skills necessary to launch the business. For example, the participants may use game resources to learn certain marketing skills such as branding and advertising. In addition, the participants may learn (418) pitch skills for presenting the business plan to potential investors. In this regard, the participants may be prompted to present (420) a pitch for an AI assistant or a human mentor.

At this point, a determination (422) may be made as to whether the business plan is ready to be pitched to potential impact investors. There are a variety of ways that this determination may be made, including an appraisal by AI or human judges. In one implementation, game credits are accumulated (426) in connection with meeting various benchmarks and receiving scores at various intermediate checkpoints. The game credits may be used to determine whether the business plan is ready for the impact investment marketplace. For example, this may involve comparing the amount of the game credits to a predetermined threshold, comparing the amount of the credits to a threshold that varies depending on the game credits of competing business plans, or allowing potential investors to use the game credits as a factor in considering whether to entertain a pitch.

If a business plan is determined not to be ready for presentation to the marketplace, the participants may be afforded an opportunity to revise (424) the business plan in an attempt to gain access to the marketplace, or partner with cross-sector organizations to further develop the plan to help it get to a point where participants can gain access to the investment marketplace. Such revisions may relate to technical feasibility, business feasibility, and quality of presentation, among other things. Once the proposed business plan is ready, it may be pitched (428) to potential investors. In some cases, the business plan may receive (430) funding. At that point, the participants and/or others who have been selected to run the business, may execute (432) the business plan. A portion of the investment and/or proceeds of the business may be returned to the game community for scholarships, improved resources, and sustainment of the game community.

A crypto currency may be employed in the game or in the impact investment community. For example, game participants may be awarded crypto currency tokens as game credits or in recognition of meritorious actions. For example, tokens may be awarded based on acts of kindness as recognized by the game community. The tokens may be used to gain rewards or as an indication of success in the game environment. In addition, the tokens may be used to award equity in a business resulting from the effort. Investors may be awarded crypto currency in exchange for investments. The crypto currency can then be used to invest in business plans in the impact investment marketplace. The crypto currency may be unique to the game environment or may be a crypto currency having value outside of the game environment. It will be appreciated that investments may also or alternatively be made in real currency or another cryptocurrency. In addition, the underlying technology of cryptocurrency being mostly blockchain, the game can utilize smart contracts to transfer the currency, and convert it to a stable coin and/or directly into the participants' local currency. Smart contracts will also be applied in cross-sector strategic partnerships that get integrated into the game.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A system for gamification of social impact entrepreneurship and cross-sector collaboration, comprising:
a design game space where gamers can select problems related to defined social impact objectives, propose dream solutions to address the problems, use game resources to identify, investigate and solve challenges associated with the dream solutions and accumulate game credits by addressing the challenges;
an entrepreneurship game space where gamers can develop dream pitches related to the dream solutions by iteratively subjecting draft pitches to game resources, receiving feedback based on analysis of the draft pitches, and revising the draft pitches based on the feedback, thereby accumulating game credits;
a launch environment that can be accessed by authenticated gamers and social impact investors, where gamers can present the dream pitches to the social impact investors, wherein the gamers can access the launch environment based on reaching a threshold of accumulated game credits;
a portal by which gamers can access the design game space and bring developed dream solutions from the design game space to the launch environment; and
a social impact investment and collaboration marketplace, associated with said launch environment, where the social impact investors can invest in one or more selected dream solutions based on the dream pitches, and strategic partners can help the solutions be successful and scale to their maximum positive impact.

2. The system of claim 1, wherein the design game space comprises a processing module that is accessed by gamers via a communications network.

3. The system of claim 2, wherein said design game space includes a digital assistant to guide gamers to identify, investigate and solve said challenges.

4. The system of claim 1, wherein said social impact investment marketplace comprises a module for online settlement of investment transactions.

5. The system of claim 4, wherein said online settlement involves a transfer of cryptocurrency.

6. The system of claim 1, further comprising a smart contract module, implemented using blockchain technology, for use in at least one of converting cryptocurrency accumulated in a game environment into hard currency and executing contracts with partner organizations.

7. A method for gamification of social impact entrepreneurship, comprising:
building a design game space where gamers can select problems related to defined social impact objectives, propose dream solutions to address the problems, use game resources to identify, investigate and solve challenges associated with the dream solutions and accumulate game credits by addressing the challenges;
generating an entrepreneurship game space where gamers can develop dream pitches related to the dream solutions by iteratively subjecting draft pitches to game resources, receiving feedback based on analysis of the draft pitches, and revising the draft pitches based on the feedback, thereby accumulating game credits;
establishing a launch environment that can be accessed by authenticated gamers and social impact investors, where gamers can present the dream pitches to the social impact investors, wherein the gamers can access the launch environment based on reaching a threshold of accumulated game credits;
building a portal by which gamers can access the design game space and bring developed dream solutions from the design game space to the launch environment; and
establishing a social impact investment marketplace, associated with said launch environment, where the social impact investors can invest in one or more selected dream solutions based on the dream pitches.

8. The method of claim 7, wherein the design game space comprises a processing module that is accessed by gamers via a communications network.

9. The method of claim 8, wherein said design game space includes a digital assistant to guide gamers to identify, investigate and solve said challenges.

10. The method claim 7, wherein said social impact investment marketplace comprises a module for online settlement of investment transactions.

11. The system of claim 4, wherein said online settlement involves a transfer of cryptocurrency.

12. The method of claim 7, further comprising providing a smart contract module, implemented using blockchain technology, for use in at least one of converting cryptocurrency accumulated in a game environment into hard currency and executing contracts with partner organizations.
